(19) United States
(12) Patent Application Publication
(10) Pub. No.: US 2006/0286966 A1
(43) Pub. Date: Dec. 21, 2006

(54) Safety system for mobile telephone keys

(75) Inventor: Alexandra Musto, Munich (DE)

Correspondence Address: BELL, BOYD & LLOYD, LLC, P. O. BOX 1135, CHICAGO, IL, 60690-1135, US

(73) Assignee: SIEMENS AKTIENGESELLSCHAFT, Munchen (DE)

(21) Appl. No.: 10/566,922

(22) PCT Filed: Apr. 30, 2004
(86) PCT No.: PCT/EP04/50660

§ 371 Date: Jan. 30, 2006

(30) Foreign Application Priority Data
Jul. 29, 2003 (EP) 03017209.2

(51) Int. Cl. H04M 1/66

(52) U.S. Cl. 455/411

(57) ABSTRACT

An apparatus and method is disclosed for protecting a mobile telephone against an unintentional switch-on wherein a pressure produced on a key is stored and evaluated, along with a substantially simultaneous pressure on one or several other keys. The mobile telephone being switched into a operating mode only when the pressure is applied on one key.

### FIELD OF TECHNOLOGY

The present disclosure relates to an apparatus and a method for protecting a mobile radio device against unintended switching on, a method for protecting a mobile radio device against unintended cancellation of a lock function and a method for protecting a mobile radio device against unintended activation of a function key.

### BACKGROUND

Mobile radio devices or mobile telephones are becoming smaller and smaller and can now easily be carried in a trouser pocket. To protect them against unintended switching on, mobile radio devices are generally protected by a fold down cover over the keypad or a hard case. This protection influences the design of the device.

Mobile radio devices are generally switched on by what is known as a long press or pressing the on/off key for a predefined period. Without additional mechanical protection, mobile telephones that are switched off can be inadvertently switched on whilst being carried in a trouser pocket and chargeable calls or internet access can even be initiated.

### SUMMARY

Accordingly, an apparatus and method is disclosed to improve the protection of a mobile radio device against unintended switching on and to protect it against unintended cancellation of a lock function.

### BRIEF DESCRIPTION OF DRAWINGS

The various objects, advantages and novel features of the present disclosure will be more readily apprehended from the following Detailed Description when read in conjunction with the enclosed drawings, in which:

FIG. 1 illustrates a mobile device and key pressure applied to different keys; and

FIG. 2 illustrates a processing sequence for evaluating key presses under an exemplary embodiment.

### DETAILED DESCRIPTION

The exemplary embodiments disclosed herein is based on the assumption that a mobile telephone carried in a trouser pocket is not switched on by a clean long press with uncontrolled key activation, but that the pressure exerted by the trouser pocket is distributed more or less regularly over a number of keys.

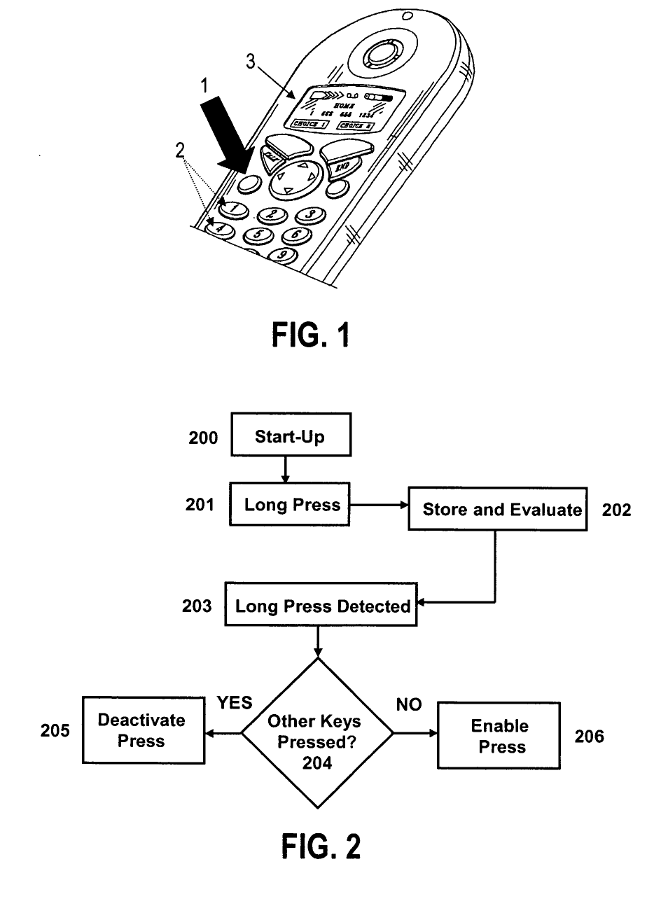

In FIG. 1, the pressure 1 applied to a key with or shortly after the long press 201 is stored and evaluated 202 for example during or after start-up 200. As the process in FIG. 2 illustrates. If other keys 2 have been pressed at the same time or almost at the same time as the long press on the on/off key (203, 204), or a number of keys were pressed at the same time just after this, it is assumed that this is unintended and the device is switched off again 205. The mobile radio device is therefore only switched to operating mode, if a pressure is applied for a predefined period to the on/off key and no further keys have been pressed during this time period 206.

Alternately, it is also possible for example to protect a locked keypad in the same manner. The key press to cancel the lock function on a predefined lock key is monitored in the same manner, so that unintended cancellation of the key lock is prevented.

The same method can also be used to protect soft keys and speed call keys. Thus when a device is switched on, if the user has for example forgotten to lock the keypad, it is therefore possible to prevent unintended internet access and calls from the telephone book or using speed dial. Such protection can be offered to the user as a permanent active option. It is then still possible to switch off the mobile radio device but it is not possible to forget to activate key lock.

In one embodiment of the invention such protection is offered to the user as an option, for example via the menu 3.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1-4. (canceled)

5. A method for protecting a mobile radio device against unintended operating mode, comprising:
storing a pressed “on” key and an almost simultaneously pressed one or more other keys;
evaluating the pressed “on” key in relation to the one or more pressed keys; and
switching the device to the operating mode only if the only key alone is pressed.

6. A method for protecting a mobile radio device against unintended cancellation of a lock function, comprising:
storing a pressed lock key and an almost simultaneously pressed one or more other keys;
evaluating the pressed lock key in relation to the one or more pressed keys; and
canceling the key lock only if the lock key along is pressed.

7. A method for protecting a mobile radio device against unintended activation of a function key, comprising:
storing a pressed function key and an almost simultaneously pressed one or more other keys;
evaluating the pressed function key in relation to the one or more pressed keys; and
activating the associated function if the function key alone is pressed.

8. The method according to claim 3, wherein the method for protecting the mobile device is performed as an option in a menu.
